(19) United States
(12) Patent Application Publication
(10) Pub. No.: US 2004/0039913 A1
(43) Pub. Date: Feb. 26, 2004

(54) Method and system for watermarking digital content and for introducing failure points into digital content

(76) Inventor: Sky Kruse, Seattle, WA (US)

Correspondence Address: OLYMPIC PATENT WORKS PLLC, P.O. BOX 4277, SEATTLE, WA, 98104, US

(21) Appl. No.: 10/417,803

(22) Filed: Apr. 16, 2003

Related U.S. Application Data
(60) Provisional application No. 60/373,128, filed on Apr. 16, 2002.

(51) Int. Cl. H04L 9/00

(52) U.S. Cl. 713/176

(57) ABSTRACT

In one embodiment of the present invention, digital audio content is analyzed with respect to specific compression/decompression algorithms to identify watermark modification points and degradation modification points within a particular digital audio file for insertion of watermarks and failure points. Watermarks contain information, such as a numerical label or identification tag, and other information, into the digital audio content in such a way that the watermark is virtually imperceptible to a listener and in such a way that the watermark survives compression and decompression by popular digital-content-compression-and-decompression tools. Failure points involve inserting additional, imperceptible signals at degradation modification points within digital audio content that, upon compression and decompression by means of common digital-content-compression-and-decompression tools, results in a markedly perceptible and annoying degradation of the audio content. Using watermarks, audio content may be labeled, so that the source of a pirated copy can be recognized. Failure points serve as Trojan horses, not affecting the audio content as originally distributed, but perceptibly degrading digital audio content that has been copied or pirated using digital-content-compression-and-decompression tools. In a second embodiment, watermarks and failure points are inserted into video digital content, in a manner similar to the insertion of watermarks and failure points into digital audio content. In additional embodiments, watermarks and failure points are inserted into additional types of digital content.

### TECHNICAL FIELD

The present invention relates to methods and systems for securing digital content from unauthorized copying and, in particular, to a method and system for inserting encoded information into digital content that survives digital-content compression and decompression, and for inserting imperceptible failure points into digital content that, upon compression and decompression, result in perceptible degradation of the digital content.

### BACKGROUND OF THE INVENTION

During most of the 20^{th} century, various types of information and recorded entertainment, such as audio recordings and movie/video recordings, were stored as analog data on traditional analog storage media, such as phonograph records, movie film, and video tapes. However, in the latter part of the 20^{th} century, digital encoding of recorded entertainment and information was developed and popularized along with the popularization of home computers and the Internet. Digital content, such as digital audio recordings and digital video recordings, can be almost limitlessly reproduced without perceptible degradation of the content. This is a tremendous advantage for ease of dissemination of entertainment and information products, but is also a tremendous disadvantage, with respect to securing digital content from unauthorized copying and pirating. For example, the Internet has become a popular means for distributing pirated music using peer-to-peer file-sharing systems in combination with high-quality audio compression and decompression tools and relatively high bandwidth transfer capabilities. It has become popular for audio consumers to download pirated audio content in the form of MP3 compressed audio files and/or to download pirated video in the form of MPEG-4 compressed video files. Widely available compression/decompression tools enable large volumes of digital content, otherwise prohibitively time consuming to transfer over the Internet, to be relatively quickly and easily transmitted in compressed form. Because of the widespread availability of digital-content-compression-and-decompression tools, authors, songwriters, performers, producers, digital-content distributors, and other individuals and businesses concerned with producing and disseminating digital content, have recognized the need for a method and system to produce and distribute digital content in a form that is difficult or unsatisfactory for compression, transmission, and decompression via the popular digital-content-compression-and-decompression tools commonly employed by unauthorized distributors and consumers of pirated digital content.

### SUMMARY OF THE INVENTION

In one embodiment of the present invention, digital audio content is analyzed with respect to specific compression/decompression algorithms to identify watermark modification points and degradation modification points within a particular digital audio file for insertion of watermarks and failure points. Watermarks contain information, such as a numerical label, identification tag, or other information, into the digital audio content in such a way that the watermark is virtually imperceptible to a listener and in such a way that the watermark survives compression and decompression by popular digital-content-compression-and-decompression tools. Failure points involve inserting additional, imperceptible signals at degradation modification points within digital audio content that, upon compression and decompression by means of commonly available digital-content-compression-and-decompression tools, result in a markedly perceptible and annoying degradation of the audio content. Using watermarks, audio content may be labeled, so that the source of a pirated copy can be recognized. Failure points serve as Trojan horses, not affecting the audio content as originally distributed, but perceptibly degrading digital audio content that has been copied or pirated using digital-content-compression-and-decompression tools.

In a second embodiment, watermarks and failure points are inserted into video digital content, in a manner similar to the insertion of watermarks and failure points into digital audio content. In additional embodiments, watermarks and failure points are inserted into additional types of digital content.

### BRIEF DESCRIPTION OF THE DRAWINGS

FIG. 1 shows a number of different waves plotted together on a common plot of amplitude versus time.

FIG. 2 shows the frequency spectrum of a musical signal at a particular instant in time.

FIG. 3 shows an essentially continuous plot of amplitude versus frequency resulting from spectral analysis of a musical signal.

FIG. 4 illustrates the analysis of a frequency spectrum of an audio signal, representing the audio signal at a particular instant in time, in order to generate a sample-point set.

FIG. 5 illustrates a digital encoding of one instant of an audio signal.

FIG. 6 shows sample points retrieved from a decompressed amplitude/frequency-pair table plotted in an amplitude-versus-frequency plot.

FIG. 7 shows a smooth fit of the sample points plotted in FIG. 6 to regenerate the originally compressed audio signal.

FIGS. 8A-E illustrate identification of a suitable modification point for insertion of a potential failure point into an audio signal.

FIGS. 9A-F illustrate, using flow-control diagrams, an implementation of an automated digital-audio-content-modification program that represents one embodiment of the present invention.

### DETAILED DESCRIPTION OF THE INVENTION

One embodiment of the present invention is a method and system for watermarking and introducing failure points into digital audio content. This embodiment is described, in detail, below. However, digital-content watermarking and introduction of failure points into digital content is more generally useful than watermarking and introducing failure points into digital audio content. In general, the method involves analyzing particular compression/decompression algorithms with respect to particular types of digital content in order to identify suitable points within the digital content for introducing watermarks and failure points. Although the present invention is described with respect to watermarking and introducing failure points into digital audio content, it is not intended to be restricted to digital audio content, but is instead intended for application to any type of digital content that becomes commercially attractive for unauthorized copying and pirating, and for which one or more particular compression/decompression algorithms become commonly used for unauthorized copying and pirating.

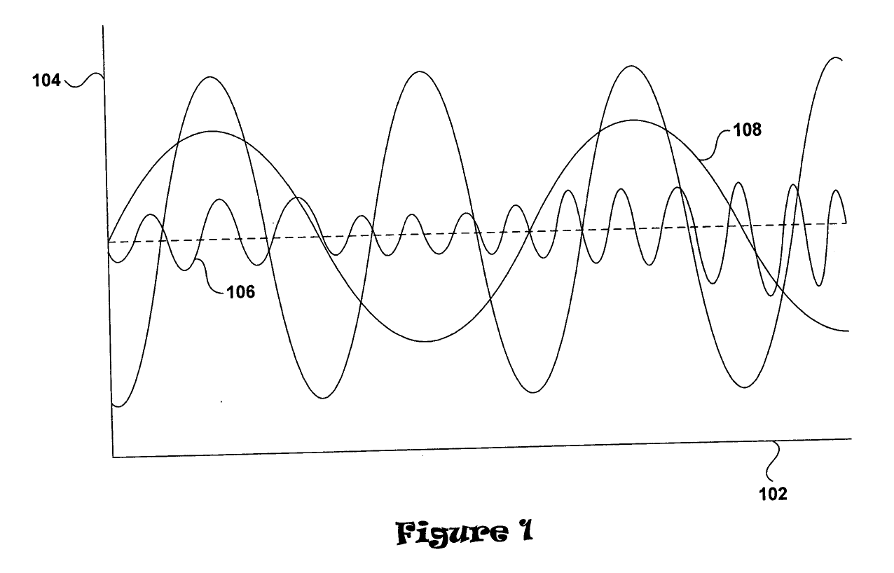

Music, either directly produced or reproduced from analog or digital recorded music, can be considered to be a combination of many different waves that produce a complex wave. Although sound involves compression waves in air, sound waves may be represented in the traditional undulating curve representation commonly used to represent electromagnetic and other types of waves. FIG. 1 shows a number of different waves plotted together on a common plot of amplitude versus time. In FIG. 1, the horizontal axis 102 is incremented in some convenient increment of time, such as milliseconds, and the vertical axis 104 represents the amplitude, or the square root of the intensity, of particular waves. The intensity of the sound at a particular instant in time is related to the square of the amplitude of the combined wave representing the sound, and the frequencies of sounds are related to the wavelengths of repeating intensity patterns in the combined wave. For example, in FIG. 1, a relatively high-frequency wave 106 oscillates, in time, at short time intervals, while a relatively lower-frequency wave 108 oscillates at comparatively longer time intervals.

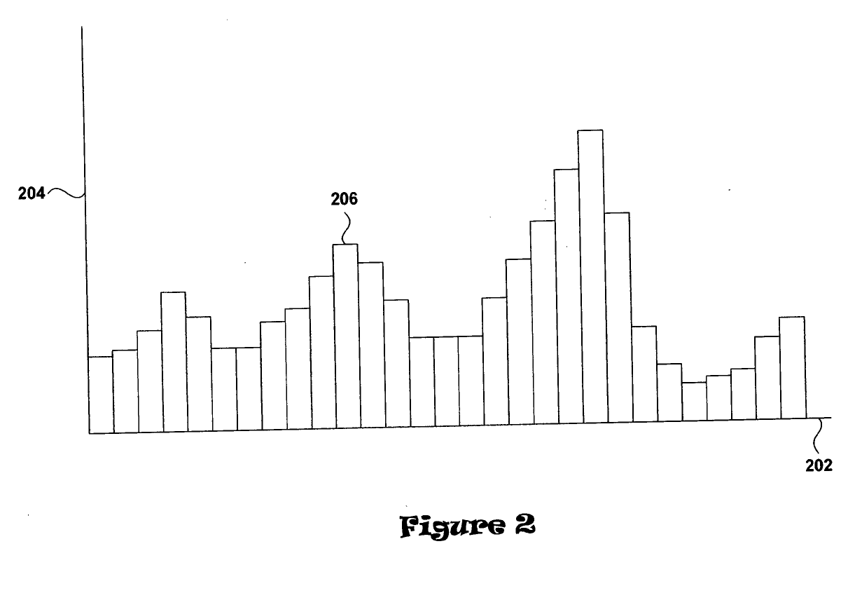

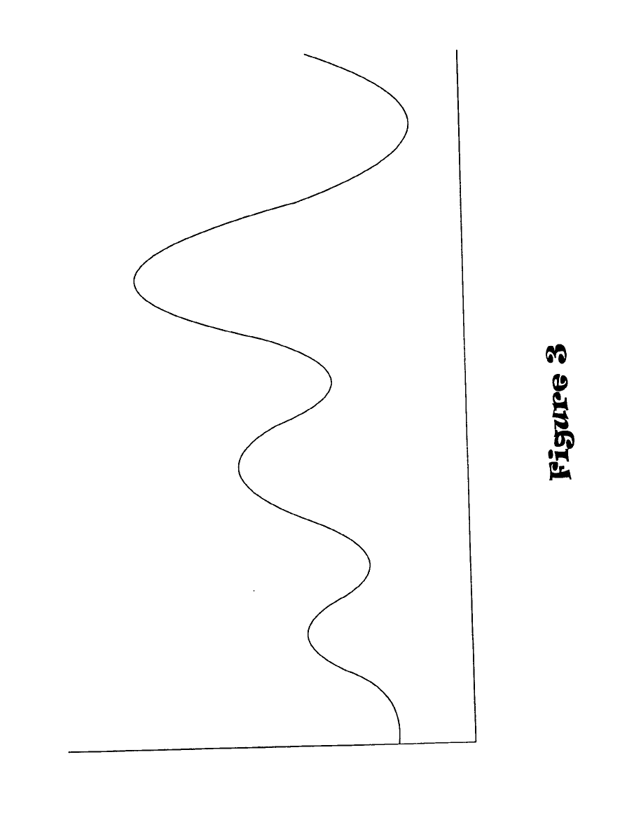

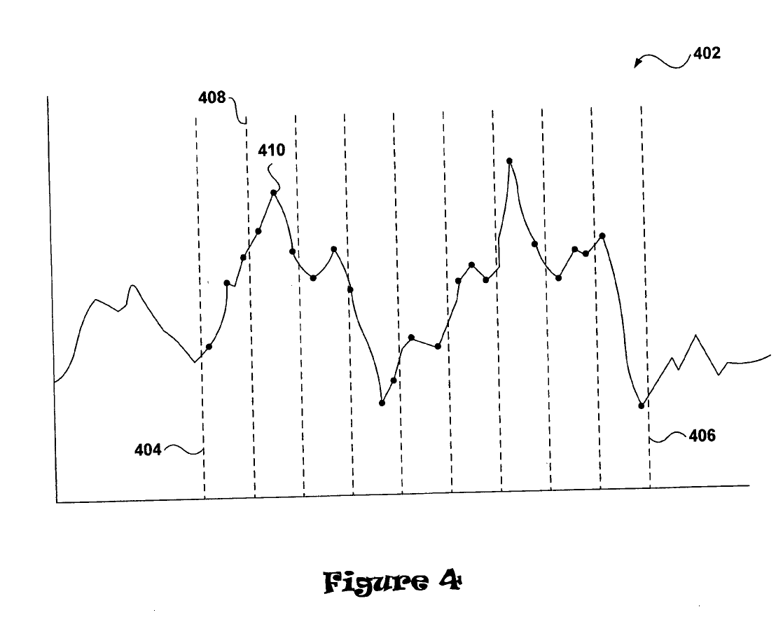

A common approach to analyzing the complex combinations of various component waves in musical sounds is to mathematically transform the combined waves, via a Fourier Transform, to produce a frequency spectrum of the sound at a particular instance in time. FIG. 2 shows the frequency spectrum of a musical signal at a particular instant in time. In a frequency spectrum, the horizontal axis 202 is divided into small frequency ranges. The amplitude of the component waves of the musical signal with frequencies within a particular frequency range is plotted as a vertical column with a height equal to the amplitude of the component waves at the particular frequency, plotted against the vertical amplitude axis 204. For example, column 206 may correspond to all component waves within a musical sound, at a particular instant in time, corresponding to frequencies between one kHz and two kHz. If the frequency intervals at which amplitude is sampled are relatively small, an essentially continuous amplitude-versus-frequency plot can be prepared for a musical sound at any particular instant in time. FIG. 3 shows an essentially continuous plot of amplitude versus frequency resulting from spectral analysis of a musical signal.

Various types of audio compression/decompression algorithms have been developed. A very general description of one popular audio decompression/compression algorithm is next provided. This general description is provided to facilitate a general discussion of techniques for introducing watermarks and failure points into digital audio content compatible with a particular compression/decompression algorithm. The exact details of a particular compression/decompression algorithm must be analyzed with respect to a particular digital audio file in order to identify modification points within the audio file for watermarks and failure points. A complete, quantitative description of the compression algorithm is neither provided nor necessary to understand the present invention.

In general, a compression algorithm seeks to sample an audio signal, at relatively short, fixed intervals in time, in order to produce a discontinuous set of sample points from which the audio signal can later be regenerated during decompression. One can think of the process as analyzing a large set of continuous frequency spectra, such as the one shown in FIG. 3, in order to select a set of sample points from each frequency spectrum to represent that, in discrete fashion, represent the continuous frequency spectrum. The audio signal is therefore represented as a series of sample-point sets, discretely representing the continuous audio signal at particular points in time. FIG. 4 illustrates the analysis of a frequency spectrum of an audio signal, representing the audio signal at a particular instant in time, in order to generate a sample-point set. As shown in FIG. 4, the amplitude-versus-frequency curve 402 of an audio signal at a particular instant in time can be cropped, and a selected portion of the amplitude-versus-frequency curve can be divided into frequency ranges, or compression bands. The amplitude-versus-frequency signal is cropped by selecting a lowest-perceptible frequency 404 and a highest-perceptible frequency 406 and discarding those portions of the audio signal that fall outside the range beginning with the lowest-perceptible frequency and ending with the highest-perceptible frequency. The cropped portion of the amplitude-versus-frequency curve can then be divided into compression bands, indicated in FIG. 4 by vertical dotted lines, such as vertical dotted line 408. Then, the compression algorithm seeks to select a small number of discrete points, such as point 410, within each compression band to represent the amplitude-versus-frequency curve section within that compression band.

The sample points may be selected with respect to a number of different criteria. Much of the selection criteria fall into an area referred to as psychoacoustics. For example, it is well known that loud sounds often mask softer sounds when the loud and softer sounds occur simultaneously, especially if the two sounds are close in frequency. Thus, a softer sound close in frequency to a louder sound may be removed, or not encoded, without perceptibly altering the perceived audio signal, a process referred to as auditory masking. In temporal masking, a very loud sound immediately followed by a softer sound often masks the softer sound, making it imperceptible even when it would be otherwise perceptible. Thus, for example, a compression algorithm may select points, within compression bands, that fall at or near maxima along the amplitude-versus-frequency curve within the compression band and may analyze successive amplitude-versus-frequency curves in order to select frequency points within compression bands that potentially masking lower-amplitude signals at neighboring frequencies. There are, in addition to auditory masking and temporal masking, many other types of easily analyzed psychoacoustic effects that enable a compression algorithm to select discrete frequency points in order to best characterize an audio signal at each instance in time.

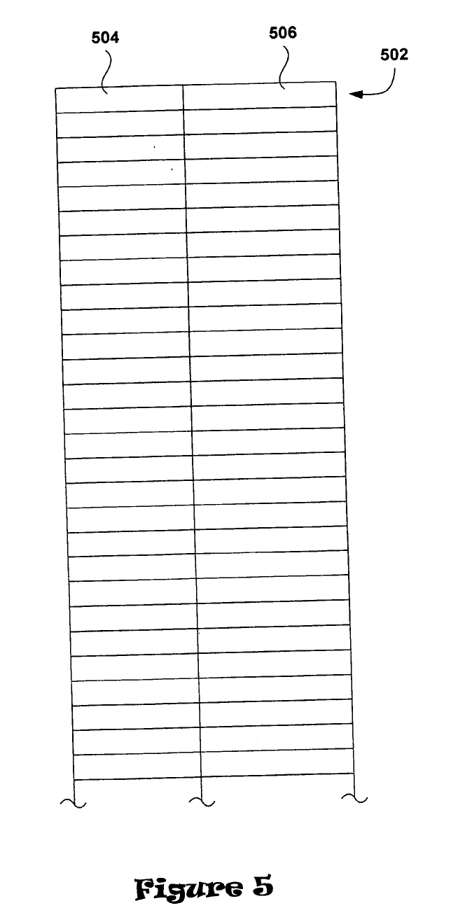

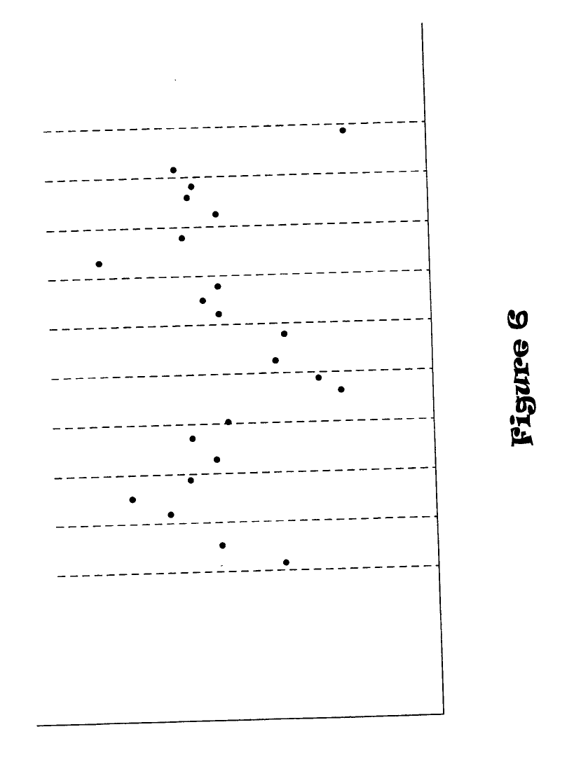

The compression algorithm may generally apply various transformations separately to the sample points in different compression bands to adjust the audio-signal representation according to psychoacoustics and other criteria. The transformed, selected sample points are then digitally stored into a table of frequency/amplitude pairs. FIG. 5 illustrates a digital encoding of one instant of an audio signal. As shown in FIG. 5, each of the discrete, chosen sample point is represented by a row, such as row 502, in a table of frequency/amplitude pairs. Each sample point is associated with a digitally encoded number representing the frequency of the sample point, such as frequency 504, and a digitally encoded number representing the amplitude of the frequency at the particular instant in time within the audio signal, such as amplitude 506. This table of frequency/amplitude pairs can then be further compressed by various digital-data compression tools, such as Huffman encoding, to further compress the digital representation of the continuous frequency spectrum. An audio signal is thus represented by a large number of digital representations of frequency spectra at regular, short time intervals, and the digital representations are then compressed to produce a compressed digital audio file.

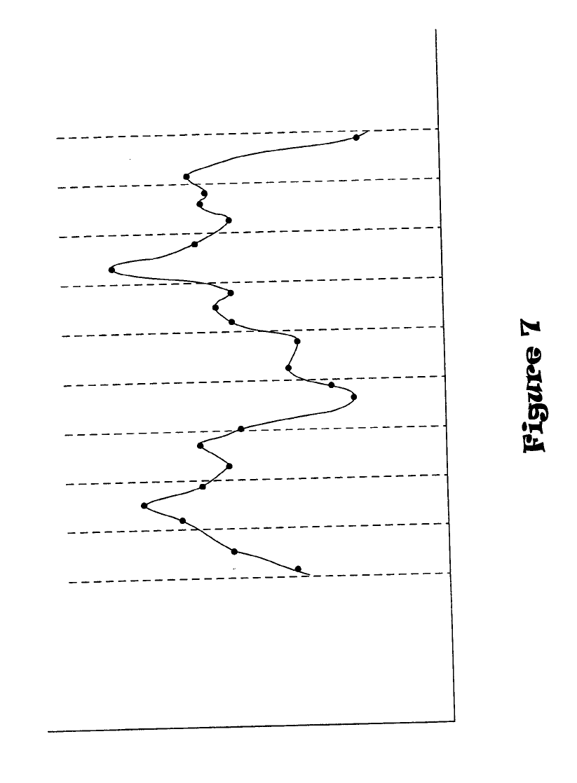

Decompression of a compressed digital audio file involves applying common decompression tools, such as decompression tools for decompressing Huffman-encoded digital data, to regenerate the frequency/amplitude pair tables, shown in FIG. 5. The sample points may then be retrieved from the table and ordered with respect to frequency and amplitude. FIG. 6 shows sample points retrieved from a decompressed amplitude/frequency-pair table plotted in an amplitude-versus-frequency plot. Next, an approximation of the original amplitude-versus-frequency curve can be reconstructed by smooth fitting the sample points. FIG. 7 shows a smooth fit of the sample points plotted in FIG. 6 to regenerate the originally compressed audio signal. Note that, in practice, the compression and decompression algorithms are mathematical in nature, and do not involve amplitude-versus-frequency plots, but rather computational manipulation of digital data. These plots are used to illustrate the types of manipulations that are carried out. Also note that the smooth fitting does not produce truly continuous frequency spectra, but rather a closer, discrete approximation of continuous frequency spectra.

Analysis of a compression/decompression algorithm can reveal various modification points for insertion of watermarks and failure points. In general, a modification point suitable for a watermark is particularly unsuitable for a failure point, and a modification point suitable for a failure point is particularly unsuitable for a watermark. Thus, modifications for watermarks and insertion of failure points tend to be mutually exclusive, non-intersecting sets.

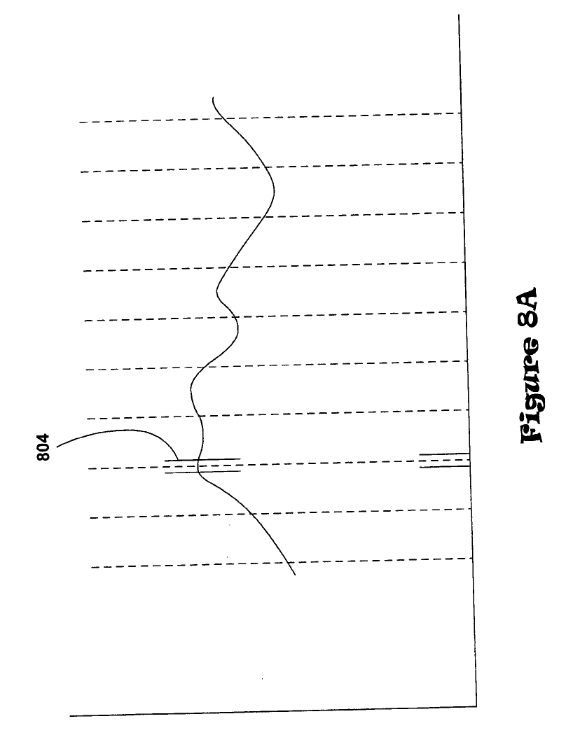

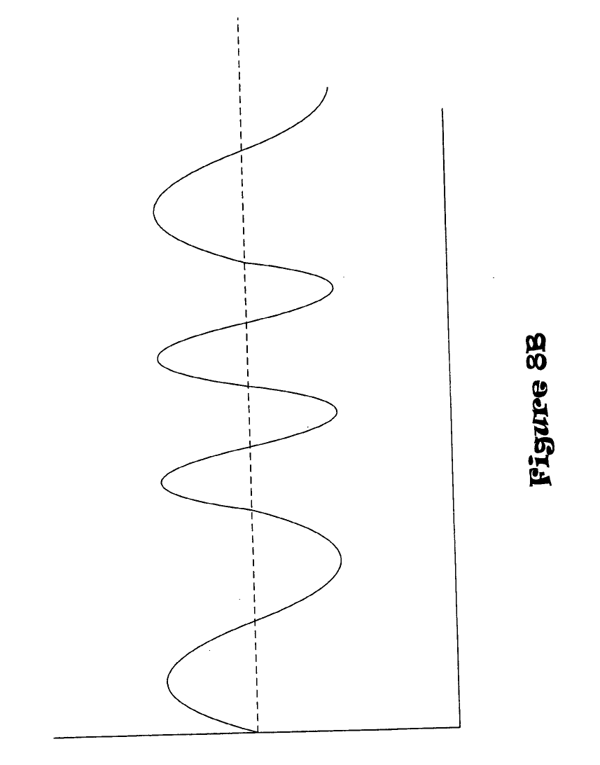

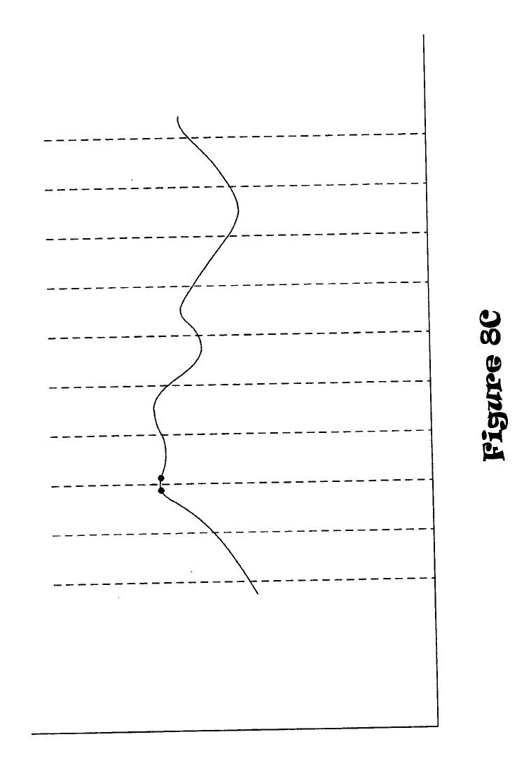

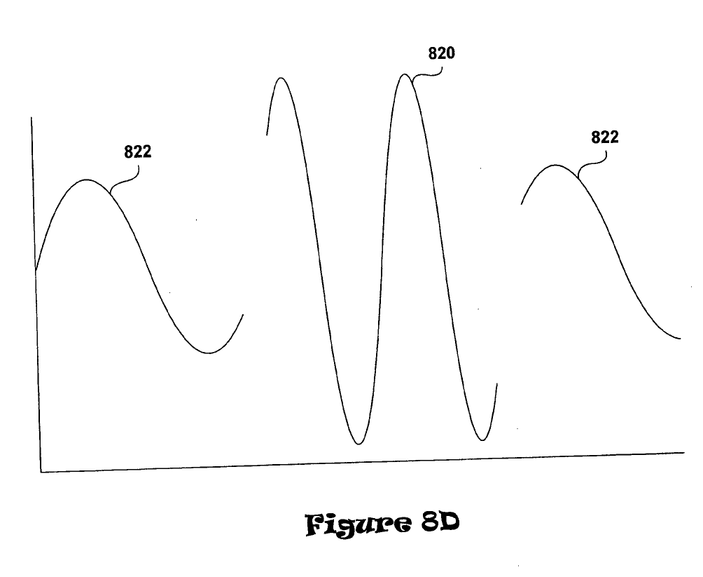

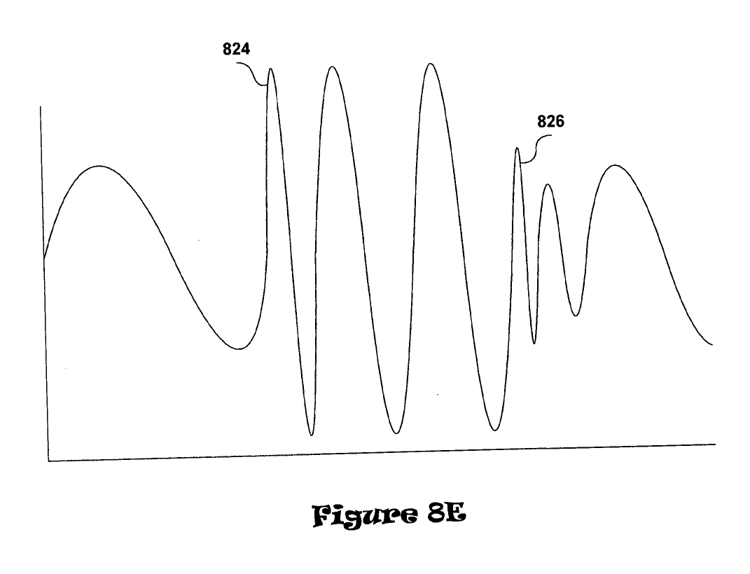

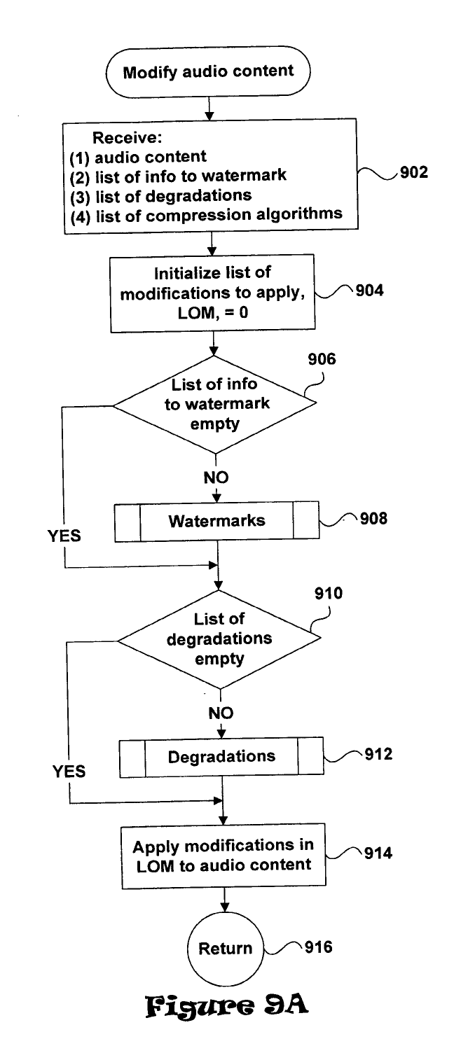

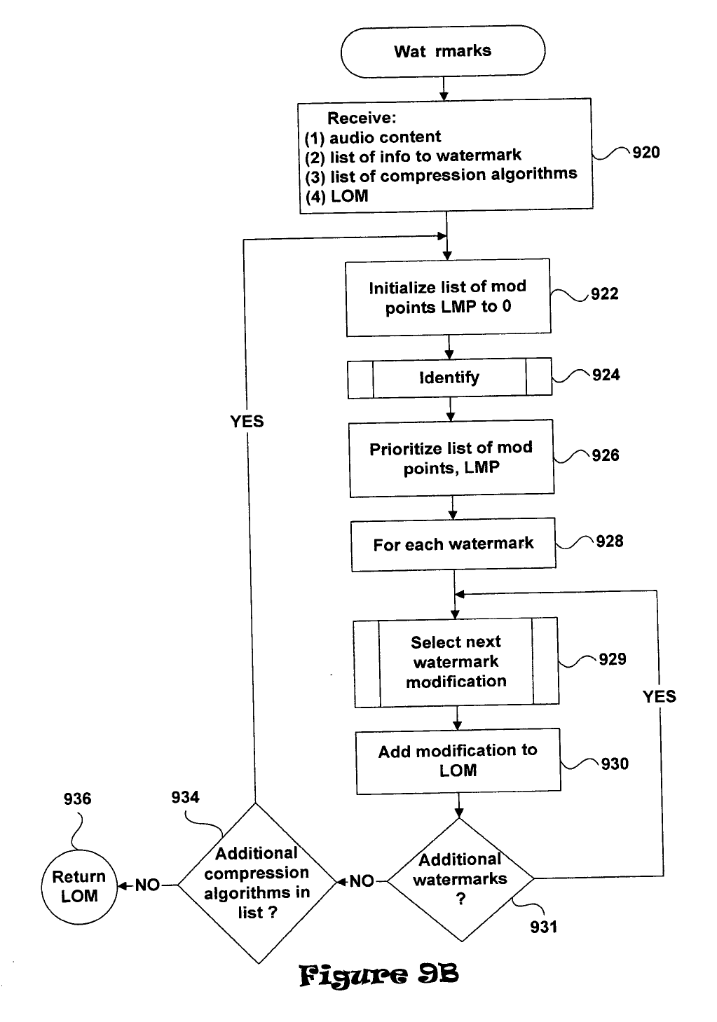

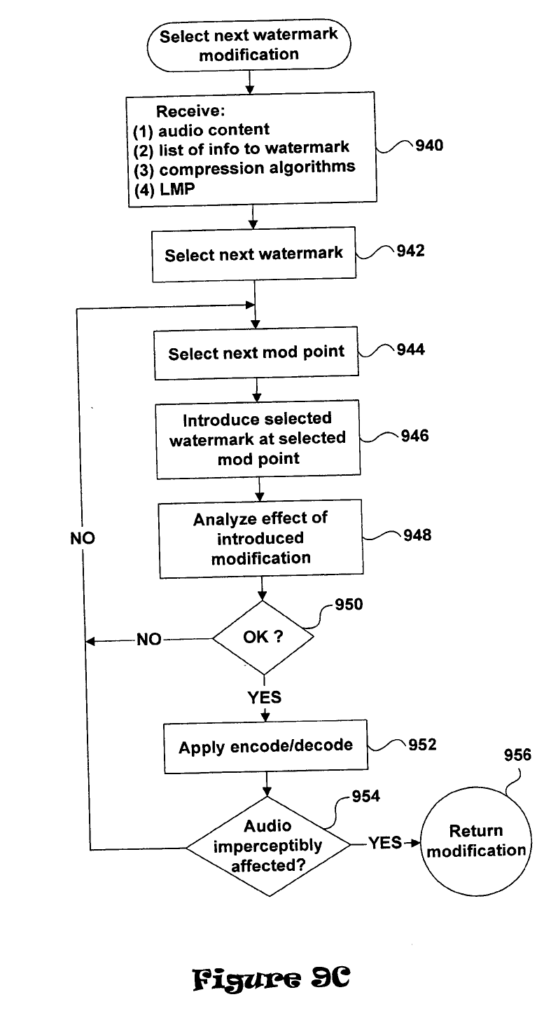

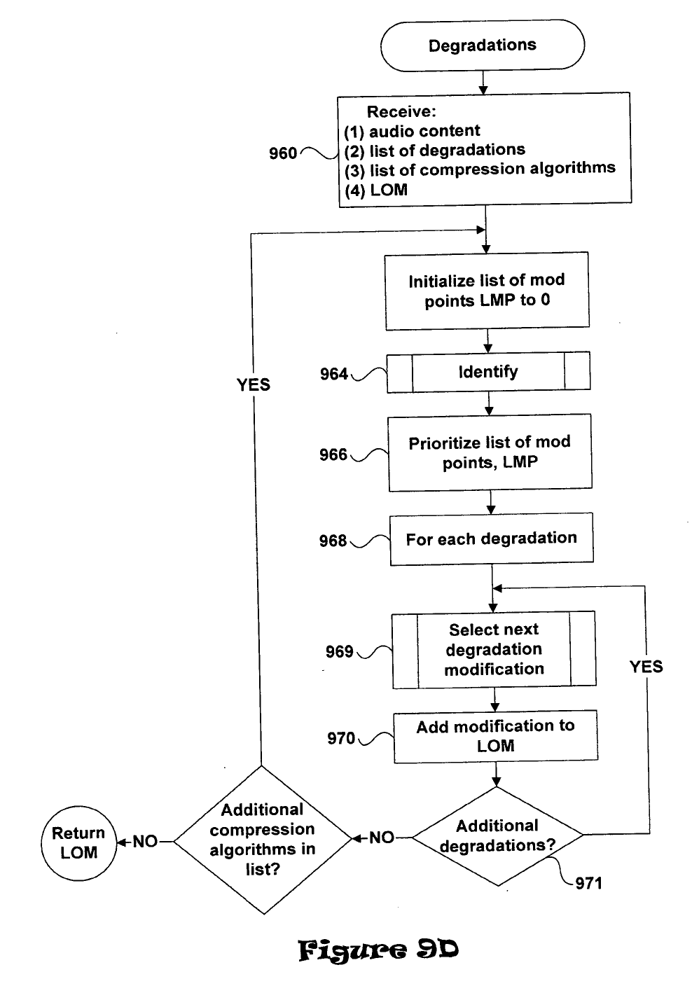

FIGS. 8A-E illustrate identification of a suitable modification point for insertion of a potential failure point into an audio signal. FIG. 8A shows the continuous frequency spectrum of an audio signal at a particular instant in time. FIG. 8A, in addition, shows the compression bands that would be constructed and applied by a particular compression algorithm. Analysis of the compression algorithm may identify a small frequency range 804 that spans a compression-band boundary in which it is highly likely that the compression band will select sample points over the course of many successive time/sample intervals. If an additional, artificial signal is introduced within this range, it is highly likely that the artificial signal will contribute to sample points collected by the compression algorithm. If the artificial signal varies slightly in frequency, as shown in the amplitude-versus-time plot of the artificial signal in FIG. 8B, it is likely that sample points associated with the added artificial signal will alternately or intermittently fall into each of the two adjacent compression bands spanned by the small frequency range (804 in FIG. 8A), as shown in FIG. 8C.

As discussed above, a compression algorithm applies different types of processing to each different compression band. A particular compression band may be essentially boosted or diminished in intensity with respect to neighboring compression bands, depending on various filtering and digital encoding manipulations applied by the compression algorithm on a compression-band-by-compression-band basis. Thus, an added signal, such as that shown in FIG. 8B, that inhabits a small frequency range that spans a compression-band boundary may result in a discontinuity upon decompression, as shown in FIG. 8D. The compression algorithm has treated the higher-frequency portion 820 that falls in a higher-frequency compression band differently from the slightly lower-frequency portion of the signal 822 that falls in an adjacent lower-frequency compression band. The smoothing algorithm may introduce artificial wave sections, such as the artificial wave sections shown in FIG. 8E 824 and 826, to span the discontinuity, thereby introducing an annoying, artificial popping or wobbling sound into the audio signal.

The above-described process for identifying the potential failure modification point is but one of many possible types of modification points suitable for introducing failure points into an audio signal. For example, harmonics and overtones that fall into different compression bands from related tones within the audio signal may constitute suitable insertion points for failure points.

By contrast, sample points that are reliably selected by compression algorithms and that fall in a central-frequency range of a compression band may serve as excellent candidates for encoding watermarks. Watermarks need to survive compression and decompression, and introduce no perceptible signal into either the original digital content or the decompressed, or restored, digital content.

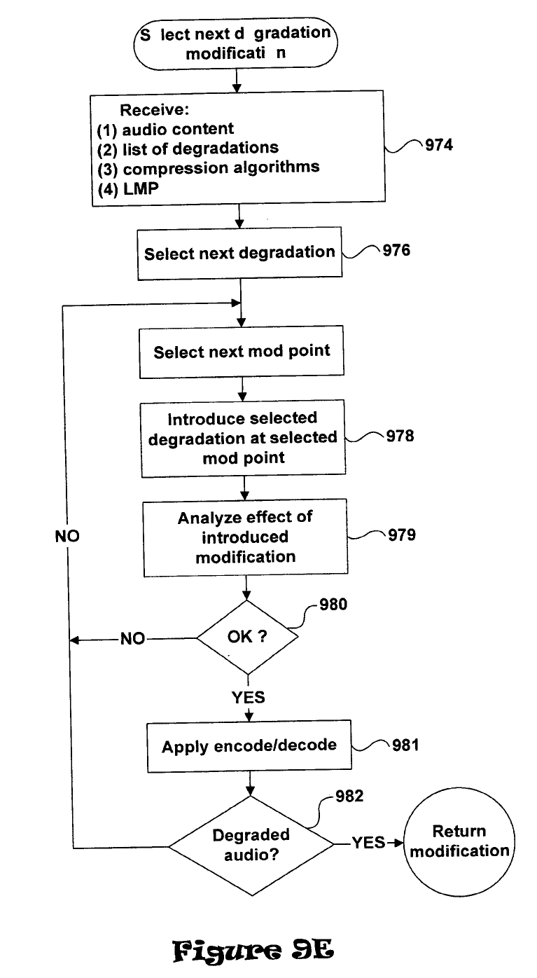

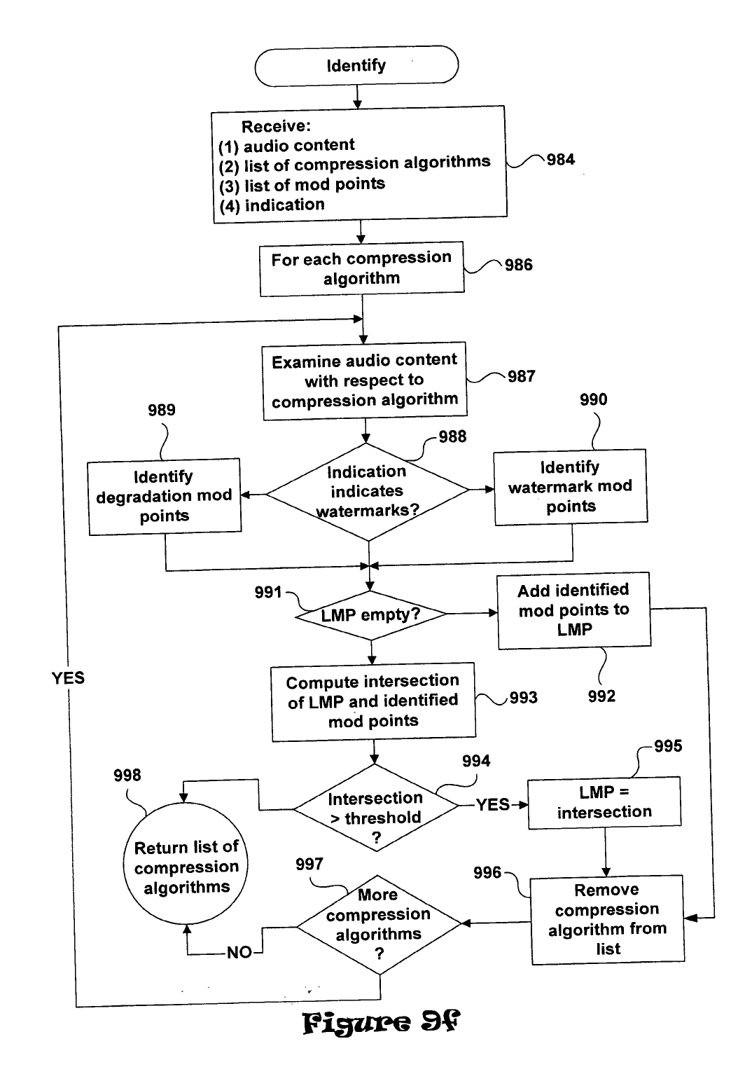

The method of watermark insertion and failure-point insertion into audio files, that represents one embodiment of the present invention, may be practiced by painstaking manual analysis and audio-signal modification using currently available audio-spectrum analysis and audio-signal-editing tools. However, a more desirable approach is to implement this method as an automated digital-audio-content-modification tool that enables automated watermarking and failure-point insertion into digital audio content. FIGS. 9A-F illustrate, using flow-control diagrams, an implementation of an automated digital-audio-content-modification program that represents one embodiment of the present invention.

FIG. 9A is a flow-control diagram for the program “modify audio content.” In step 902, the program receives four input parameters: (1) a digital-audio-content file that needs to be modified; (2) a list of information units, such as numbers or labels, that need to be inserted as watermarks into the digital-audio-content file; (3) a list of failure points, or degradations, that need to be inserted into the digital-audio-content file; and (4) a list of compression algorithms that the inserted watermarks and failure points, or degradations, need to be compatible with. In step 904, the program initializes a list of modifications to apply to the digital-audio-content file (“LOM”) to the empty list, or, equivalently, the NULL set. Next, in step 906, the program determines whether or not the input list of information units for insertion by watermarking is empty. If the list is not empty, then the routine “watermarks” is called in step 908 to generate modifications that are added to the LOM. Then, in step 910, the program determines whether the list of failure points, or degradations, input to the program is empty. If the list is not empty, then the routine “degradations” is called, in step 912, to produce corresponding modifications that are added to the LOM. Finally, in step 914, the modifications that have been added to the LOM via calls to the routines “watermarks,” in step 908, and “degradations,” in step 912, are applied to the audio signal to produce modified audio content that includes information inserted as watermarks and that includes failure points, or degradations, that produce degradation of the audio signal upon compression and decompression of the audio signal by one of the compression/decompression algorithms supplied in the input list of compression algorithms. The program then returns, in step 916.

FIG. 9B is a flow-control diagram for the routine “watermarks” called in step 908 of the program “modify audio content,” illustrated in FIG. 9A. In step 920, the routine “watermarks” receives the following input parameters: (1) the digital audio content file into which watermarks are to be inserted; (2) a list of information units that need to be inserted into the digital-audio content file as watermarks; (3) a list of compression algorithms; and (4) a LOM. In step 922, the routine “watermarks” initializes a list of modification points (“LMP”) to the empty list or, equivalently, the NULL set. Next, in step 924, the routine “watermarks” invokes the routine “identify” to identify suitable modification points for watermarks within the digital-audio-content file. In step 926, the routine “watermarks” receives the LMP produced by the routine “identify,” in step 924, and prioritizes the list in descending order of suitability for insertion of watermarks. The suitability may be computed based on various characteristics indicative of the suitability of a modification point for a watermark, including the reliability of selection of sample points by the compression algorithm from the modification point, the imperceptibility of a signal added to the modification point, and other such criteria. Next, in the for-loop comprising steps 928-931, the routine “watermark” iteratively generates watermark modifications via a call to the routine “select next watermark modification,” in step 929, passing a list of compression algorithms for which the watermark needs to be compatible to the routine “select next watermark modification,” and adds the modification to the LOM in step 930. When no additional information units need to be inserted as watermarks, as determined in step 931, the routine “watermark,” in step 934, determines whether any additional compression algorithms remain in the input list of compression algorithms, employed as a local variable by the routine “watermarks.” If any additional compression algorithms remain in the list, as determined in step 934, control flows back to step 922 in order for the routine “watermarks” to insert additional modifications into the LOM for the remaining compression algorithms. If no additional compression algorithms remain, as determined in step 934, then the routine “watermarks” returns the LOM in step 936.

FIG. 9C is a flow-control diagram of the routine “select next watermark modification.” In step 940, the routine “select next watermark modification” receives: (1) the digital-audio-content file into which watermarks and failure points need to be inserted; (2) a list of information units that need to be inserted into the digital-audio-content file via watermarks; (3) a list of compression algorithms that an inserted watermark needs to be compatible with; and (4) a list of modification points, LMP. In step 942, the routine “select next watermark modification” selects the next information unit in its watermark from the list of information units to watermark, received as an input parameter. Then, in step 944, the routine “select next watermark modification” selects the next modification point from the LMP. In step 946, the routine “select next watermark modification” introduces the selected watermark at the selected modification point in a copy of the digital-audio content and, in step 948, analyzes the effect of having introduced the modification at the modification point. This analysis may involve fast-fourier-transform (“FFT”) based analysis to detect various patterns or characteristics previously identified as indicative of an unacceptably perceptible change or degradation. If the watermark proves to be imperceptible within the audio signal represented by the digital-audio content, as detected in step 950, then control flows to step 952, where the compression algorithms received as an input parameter are applied to the audio signal to first compress and then restore the audio signal. The restored audio signals are then analyzed and, if the restored audio signals following compression and decompression remain imperceptibly affected by the watermark, as detected in step 954, again using FFT-based analysis or other automated analyses, then the modification comprising the selected watermark and selected modification point are returned, in step 956, as a modification to be applied to the digital-audio-content file. However, if the watermark is not imperceptible following introduction of the watermark into the original digital-audio-content file, as detected in step 950, or if the watermark becomes perceptible following compression and decompression, as detected in step 954, then control flows back to step 944 for selection of another modification point from the LMP, and the routine “select next watermark modification” continues to iterate until an appropriate modification point is identified. The implementation of this routine, and other routines implemented in subsequent flow-control diagrams, assumes that there are a vast surplus of potential modification points compared with the number of information units to insert into the digital-audio-content file via watermarking and the number of failure points, or degradations, that need to be inserted into that file. Otherwise, additional tests would detect exhaustion of the LMP.

FIG. 9D is a flow-control diagram illustrating implementation of the routine “degradations,” called from step 912 of the program “modify audio content,” diagramed in FIG. 9A. The routine “degradations” is quite similar to the routine “watermarks,” diagramed in FIG. 9B. Therefore, in the interest of brevity, only the difference is between the routine “degradations” and the routine “watermarks,” previously described with reference to FIG. 9B, are provided. A first difference is found in step 960. In the routine “degradations,” a list of degradations is supplied as an input parameter, then a list of information units to watermark, as supplied to the routine “watermarks” in step 920. A second difference is found in step 966, in which the list of modification points, LMP, returned by a call to the routine “identify” in step 964, is prioritized in descending order of suitability for insertion of a failure point. As discussed above, points for inserting degradations are generally points at which watermarks should not be inserted, and vice versa. Thus, the prioritization that occurs in step 966 of the routine “degradations” is quite different from the prioritization that occurs in step 926 of the routine “watermarks.” A third difference is that the for-loop comprising steps 968-971 in the routine “degradations” selects, via a call to the routine “select next degradation modification” in step 969, modifications comprising modification points suitable for insertion of failure points, or degradations, rather than modification points for insertion of watermarks, as are selected in the for-loop of steps 928-931 in the routine “watermarks.”

FIG. 9E is a flow-control diagram of the routine “select max degradation modification,” invoked in step 969 of the routine “degradations,” diagramed in FIG. 9D. The routine “select next degradation modification” is similar to the routine “select next watermark modification,” diagramed in FIG. 9C. In the interest of brevity, only the differences between these two routines are discussed. A first difference occurs in step 974, in which the routine “select next degradation modification” receives a list of degradations or failure-points to apply, rather than a list of information units to watermark. A next difference occurs in step 976, in which the routine “select next degradation modification” selects a next degradation, or failure point, rather than a next watermark, as selected in step 942 of the routine “select next watermark modification.” The final differences occur in the series of steps 978-982, in which the routine “select next degradation modification” inserts degradations, or failure points, rather than watermarks, as are inserted in steps 946 through 954 of the routine “select next watermark modification.” The criteria by which the routine “select next degradation modification” determines whether or not an introduced degradation is suitable, in steps 980 and 982, is different from the criteria used in steps 950 and 954 in the routine “select next watermark modification.” In the case of insertion of degradations, or failure points, the failure point needs to be imperceptible within the original digital-audio-content file, as determined in step 980, but, in contrast to the case of watermarks, must be annoyingly and detrimentally perceptible following compression and decompression by each of the compression/decompression algorithms, as determined in 982.

FIG. 9F is a flow-control diagram of the routine “identify,” called in step 924 of the routine “watermarks,” diagramed in FIG. 9D, and in step 964 of the routine “degradations,” diagramed in FIG. 9D. In step 984, the routine “identify” receives, as input parameters: (1) a digital-audio-content file that needs to be modified by insertion of watermarks and failure points; (2) a list of compression algorithms that inserted watermarks and failure points need to be compatible with; (3) a list of potential modification points; and (4) an indication of whether the routine “identify” has been called from the routine “watermarks” or the routine “degradations.” Steps 986-997 together comprise a for-loop in which suitable modification points are added to the list of modification points LMP with respect to each compression algorithm and the received list of compression algorithms. Note that the list of compression algorithms is returned by the routine “identify” in step 998, to indicate whether or not the list of modification points be prepared by the routine “identify” is complete with respect to the supplied compression algorithms. If not, then the calling routines “watermarks” or “degradation” need themselves to iterate and call the routine “identify” in a subsequent iteration. In step 987, the routine “identify” examines the digital-audio-content file with respect to the currently considered compression algorithm, in order to determine the filtering and compression bands that the compression algorithm applies to the digital-audio-content file at each instant in time that the compression algorithm undertakes audio-signal sampling. Then, if the routine “identify” was invoked by the routine “watermark,” suitable watermark modification points are identified in step 990. Otherwise, suitable failure-point or degradation-modification points are determined in step 989. As discussed above, suitable watermark modification points are points within the audio signal, generally frequencies over a range of time within the audio signal, at which information may be encoded so that the encoded information does not perceptibly change the audio signal but so that the encoded information will survive many rounds of compression and decompression by the currently considered decompression algorithm. By contrast, suitable points for introducing failure points for degradations are points at which the failure point is imperceptible in the original audio signal, but becomes glaringly perceptible following compression and decompression by the currently considered compression algorithm. Sample points corresponding to frequencies and times suitable as modification points for degradations include sample points that are likely to be partially filtered or intermittently occurring in different compression bands. By contrast, modification points suitable for watermarks are sample points that are not likely to be partially filtered or occurring in multiple compression bands, and that are not likely to be removed during compression.

Once suitable modification points are determined in either step 989 or 990, the routine “identify,” in step 991, determines whether the LMP is currently empty or not. If it is empty, then the identify modification points are added to the LMP in step 992. Otherwise, the intersection of the modification points currently on the LMP and the modification points identified in either steps 989 or 990, is computed in step 993, and the number of modification points within this computed intersection is compared with a threshold in step 994. If the number of modification points remaining in the intersection is greater than the threshold, as determined in step 994, then the LMP is assigned to equal the intersection in step 995. Thus, with each iteration of the for-loop of steps 986-997, the set of modification points is called to insure that the modification points are suitable for all of the considered compression algorithms. If, on the other hand, the number of modification points in the intersection is not greater than the threshold, as determined in step 994, then the routine “identify” returns in step 998, returning to the calling routine both the list of compression algorithms as well as the LMP. In the case that either the LMP was empty, and the identified modification points have been added to the LMP in step 992, or the intersection of the newly identified modification points and those points previously residing on the LMP is greater than a threshold value, as determined in step 994, the currently considered compression algorithm is removed from the input list of compression algorithms, in step 996, and, in step 997, the routine “identify” determines whether or not more compression algorithms remain on the list. If so, then control flows back to step 987, for determination of a new set of modification points for a subsequent compression algorithm. Otherwise, the routine “identify” returns, in step 998, the current list of compression algorithms as well as the LMP.

Although the present invention has been described in terms of a particular embodiment, it is not intended that the invention be limited to this embodiment. Modifications within the spirit of the invention will be apparent to those skilled in the art. For example, there are an almost limitless number of ways in which the digital-audio-content-modification program that represents one embodiment of the present invention, an implementation for which is provided above with reference to FIGS. 9A-F, can be alternatively implemented, including numerous different programming languages, control flows, control structures, data structures, modular organization schemes, and other such characteristics of a software implementation. Moreover, many different considerations for selecting modification points for watermarks and degradations may be employed, depending on the particular compression algorithms for which the watermarks and degradations need to be compatible. As discussed above, the method of the present invention may be employed for inserting watermarks and failure points into any type of distributed digital content, including video digital content and other types of entertainment and informational content. In these cases, a different analysis of the compression algorithms needs to be undertaken to recognize suitable modification points for watermarks and degradations. While degradations in audio-digital content resulting in pops, clicks, wobbling tones, and other annoying artifacts following a round a compression and decompression, degradations in a video-digital content may result in image deterioration, flashes, fade outs, and other visual discontinuities, and perhaps other effects that degrade the entertainment value of the video digital content following compression and decompression. Because failure-points can be inserted into digital-content, they can also be removed from digital content if a representation of the added signal is preserved. Thus, for example, failure-points may be selectively removed, to allow an authentic digital-content purchaser to reproduce the digital content for her or his personal uses.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for encoding information within digital content as a digital watermark, the method comprising:
analyzing a compression algorithm to determine the sample points selected by the compression algorithm;
selecting a modification point within the digital content based on the determined sample points; and
encoding the information at the selected modification point within the digital content as a watermark.

2. The method of claim 1 wherein selecting a potential modification point within the digital content based on the determined sample points further comprises:
selecting potential modification points based on the determined sample points; and
iteratively
selecting a next potential modification point from the set of potential modification points,
encoding the information as an added signal within a copy of the digital content, and
compressing the copy of the digital content using the compression algorithm and decompressing the compressed digital content to produce restored digital content
until a modification point is selected at which the information may be encoded without perceptibly altering the copy of the digital content and at which the encoded information is restored after compression and decompression.

3. The method of claim 2 wherein selecting potential modification points based on the determined sample points further comprises selecting narrow frequency ranges that reliably contribute sample points to the compressed digital content over a period of time, the frequency ranges not spanning compression-band boundaries and not likely to be partially filtered by the compression algorithm.

4. The method of claim 1 wherein the information is one of:
a number;
an alphanumeric string;
a label;
a multi-field record.

5. The method of claim 1 wherein the digital content is one of:
a digital-audio-content file;
a digital-video-content file; and
a digital-multi-media-content file.

6. The method of claim 1 wherein the digital content is digital-audio content and wherein analyzing a compression algorithm to determine the sample points selected by the compression algorithm further comprises:
for each point in time at which sample points are selected by the compression algorithm,
determining those portions of the frequency spectrum of the digital content filtered by the compression algorithm;
determining the compression-band boundaries within the portion of the frequency spectrum not filtered by the compression algorithm;
determining the sample points within each compression band that are selected as being most representative of the perceived signal by the compression algorithm; and
determining which of the sample points most representative of the perceived signal are retained despite application of any additional compression techniques by the compression algorithm.

7. The method of claim 6 wherein determining the sample points within each compression band that are selected as being most representative of the perceived signal by the compression algorithm further comprises applying psychoacoustic sample-selection algorithms used by the compression algorithm, including auditory masking and temporal masking.

8. Computer instructions stored on a computer-readable medium that implement the method of claim 1.

9. Digital content modified by the method of claim 1 and stored on a computer-readable medium in a computer-readable format.

10. A computer system running a computer program that implements the method of claim 1.

11. A method for encoding a failure point within digital content, the method comprising:
analyzing a compression algorithm to determine the sample points selected by the compression algorithm;
selecting a modification point within the digital content based on the determined sample points; and
encoding the failure point at the selected modification point within the digital content.

12. The method of claim 11 wherein selecting a potential modification point within the digital content based on the determined sample points further comprises:
selecting potential modification points based on the determined sample points; and
iteratively
selecting a next potential modification point from the set of potential modification points,
encoding the failure point as an added signal within a copy of the digital content, and
compressing the copy of the digital content using the compression algorithm and decompressing the compressed digital content to produce a restored digital content
until a modification point is selected at which the failure point may be encoded without perceptibly altering the copy of the digital content, at which the encoded failure point is altered after compression and decompression to perceptibly degrade the digital content.

13. The method of claim 12 wherein selecting potential modification points based on the determined sample points further comprises selecting narrow frequency ranges that reliably contribute sample points to the compressed digital content over a period of time, the frequency ranges spanning compression-band boundaries and likely to be partially filtered by the compression algorithm.

14. The method of claim 11 wherein the failure point is as added signal.

15. The method of claim 11 wherein the digital content is one of:
a digital-audio-content file;
a digital-video-content file; and
a digital-multi-media-content file.

16. The method of claim 11 wherein the digital content is digital-audio content and wherein analyzing a compression algorithm to determine the sample points selected by the compression algorithm further comprises:
for each point in time at which sample points are selected by the compression algorithm,
determining those portions of the frequency spectrum of the digital content filtered by the compression algorithm;
determining the compression-band boundaries within the portion of the frequency spectrum not filtered by the compression algorithm;
determining the sample points within each compression band that are selected as being most representative of the perceived signal by the compression algorithm; and
determining which of the sample points most representative of the perceived signal are retained despite application of any additional compression techniques by the compression algorithm.

17. The method of claim 16 wherein determining the sample points within each compression band that are selected as being most representative of the perceived signal by the compression algorithm further comprises applying psychoacoustic sample-selection algorithms used by the compression algorithm, including auditory masking and temporal masking.

18. Computer instructions stored on a computer-readable medium that implement the method of claim 11.

19. Digital content modified by the method of claim 11 and stored on a computer-readable medium in a computer-readable format.

20. A computer system running a computer program that implements the method of claim 11.
